(19) United States
(12) Patent Application Publication
(10) Pub. No.: US 2019/0063776 A1
(43) Pub. Date: Feb. 28, 2019

(54) AIR CONDITIONING CONTROL SYSTEM, AIR CONDITIONING CONTROL APPARATUS, AND AIR CONDITIONING CONTROL METHOD

(71) Applicant: Panasonic Intellectual Property Management Co., Ltd., Osaka (JP)

(72) Inventors: AKIHIRO MICHIMORI, Hyogo (JP); MASAAKI HARADA, Osaka (JP)

(21) Appl. No.: 16/012,793

(22) Filed: Jun. 20, 2018

(30) Foreign Application Priority Data
Aug. 22, 2017 (JP) 2017-158990
Mar. 20, 2018 (JP) 2018-052768

(51) Int. Cl. F24F 11/66; F24F 11/54; F24F 11/61; F24F 11/64; F24F 11/89; G05B 15/02

(52) U.S. Cl. CPC F24F 11/66; F24F 11/54; F24F 11/61; F24F 2120/14; F24F 11/89; G05B 15/02; F24F 11/64

(57) ABSTRACT

An air conditioning control system includes a sensor that generates heat distribution information about a sleeping space, a receiver that receives information for determining the state of a person, a determiner that determines whether the state of the person is a sleep-preparation state by using the information for determining the state of the person, a gauge that gauges thermal sensation in accordance with the heat distribution information, a temperature measure that measures the temperature in the sleeping space, an air conditioner that controls the temperature in the sleeping space or the bed, and a controller that determines a set temperature of the air conditioner. The controller determines the set temperature of the air conditioner in accordance with the thermal sensation and the temperature in the sleeping space, when the first determiner determines that the state of the person is the sleep-preparation state.

### BACKGROUND

### 1. Technical Field

The present disclosure relates to an air conditioning control system, an air conditioning control apparatus, and an air conditioning control method.

### 2. Description of the Related Art

There are known techniques for controlling a bed or bedroom temperature suitable for sleep with the aim of improving the quality of sleep, which is considered to account for one-third of a person's lifespan (see, for example, Japanese Patent Nos. 3960772 and 2876882). In addition, a technique for estimating the temperature sensation of a person is known (see, for example, Japanese Patent No. 6050543).

### SUMMARY

However, there is a concern that the above-described techniques of the related art may not appropriately control the temperature in a sleeping space where a person sleeps or a bed when the person goes to sleep.

In one general aspect, the techniques disclosed here feature an air conditioning control system including a sensor that generates heat distribution information about a sleeping space, where a person sleeps, an obtainer that obtains information for determining a state of the person, a first determiner that determines whether the state of the person is a sleep-preparation state, which is a state of preparing for sleep in a bed, by using the information for determining the state of the person, a gauge that gauges thermal sensation, which is the sensation of temperature felt by the person in the sleeping space, in accordance with the heat distribution information, a first measuring unit that measures the temperature in the sleeping space, an air conditioner that controls the temperature in the sleeping space or a temperature in the bed, and a controller that determines a set temperature of the air conditioner. The controller determines the set temperature of the air conditioner in accordance with the thermal sensation gauged by the gauge and the temperature in the sleeping space measured by the first measuring unit, in a case where the first determiner determines that the state of the person is the sleep-preparation state.

According to the above-described aspect, the temperature in the sleeping space or the bed when the person goes to sleep can be appropriately controlled.

General and specific aspects may be implemented using a system, a method, and a computer program, and any combination of systems, methods, and computer programs.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating an example of a functional configuration of an air conditioning control system according to a first embodiment before a person goes to sleep;

FIG. 2 is a block diagram illustrating an example of a functional configuration of the air conditioning control system according to the first embodiment while the person is sleeping;

FIG. 3 illustrates an example of a first table;

FIG. 4 is a flowchart illustrating an example of an operation of determining a set temperature of an air conditioning unit;

FIG. 5A is a graph illustrating an example of a set temperature determined by an air conditioning control portion;

FIG. 5B is a graph illustrating another example of a set temperature determined by an air conditioning control portion;

FIG. 6 is a block diagram illustrating an example of a functional configuration of an air conditioning control system according to a second embodiment when a person is sleeping;

FIG. 7 illustrates an example of a first graph;

FIG. 8 is a block diagram illustrating an example of a functional configuration of an air conditioning control system according to a third modified embodiment when a person is sleeping; and

FIG. 9 illustrates an example of a second table.

### DETAILED DESCRIPTION

### (Underlying Knowledge Forming Basis of the Present Disclosure)

There are known techniques for rendering a thermal environment during sleep more suitable for sleep with the aim of improving the quality of sleep, which is considered to account for one-third of a person's lifespan.

For example, a heating device for controlling sleep is known. When a person goes to sleep, the heating device sets the heating temperature for the upper body to fall within a comfortable temperature range slightly lower than the body temperature, and for the lower body to a temperature higher than the comfortable temperature range and slightly lower than the body temperature. While the person is asleep, the heating device for controlling sleep adjusts the heating temperatures for the upper body and lower body to fall within a comfortable temperature range slightly lower than the body temperature.

Furthermore, there is known a bedroom-temperature-and-humidity control system including a temperature-and-humidity varying means for varying temperature and humidity in a bedroom, temperature sensors and humidity sensors for measuring temperature and humidity in a bed, and a controller for feedback controlling the temperature-and-humidity varying means in accordance with output signals of the temperature sensor and the humidity sensor. The bedroom-temperature-and-humidity control system estimates thermal sensation and sweating sensation in accordance with output signals of the temperature sensor and the humidity sensor and controls the temperature-and-humidity varying means. Thermal sensation is the sensation of temperature felt by a person, for example, hot or cold.

Moreover, there is known an air conditioner that measures body temperature and ambient temperature by using a thermal image showing a temperature distribution in a space acquired by a thermal image acquisition unit, and that estimates thermal sensation in accordance with the difference value between the body temperature and the ambient temperature. The air conditioner is controlled in accordance with the thermal sensation.

However, even if the level of heat in a person's body (hereinafter referred to as body heat level) is relatively high when a person goes to sleep, the heating device for controlling sleep in the related art heats the lower body of the person to a temperature above the comfortable temperature range. Therefore, there is a problem in which this may in turn hinder the heat radiation and thus hinder falling asleep.

Further, the bedroom-temperature-and-humidity control system of the related art controls temperature and humidity in the bed by estimating thermal sensation in accordance with temperature and humidity in the bedroom, without taking into account the body heat level. As a result, there is a problem in which a desired object may not be obtained depending on the body heat level of a person when the person sleeps.

Moreover, the air conditioner of the related art is controlled in accordance with the thermal sensation estimate based on the difference value between body temperature and ambient temperature. However, even if the thermal sensation is the same, the body heat level varies depending on ambient temperature. Thus, there is a problem in which the temperature when a person goes to sleep may not be controlled to an appropriate temperature.

On the basis of the above-described underlying knowledge, the present inventor created the configurations of the present disclosure.

An air conditioning control system according to a first aspect of the present disclosure includes a sensor that generates heat distribution information about a sleeping space where a person sleeps, an obtainer that obtains information for determining the state of the person, a first determiner that determines whether the state of the person is a sleep-preparation state, which is a state of preparing for sleep in a bed, by using the information for determining the state of the person, a gauge that gauges thermal sensation, which is the sensation of temperature felt by the person in the sleeping space, in accordance with the heat distribution information, a first measuring unit that measures the temperature in the sleeping space, an air conditioner that controls the temperature in the sleeping space or a temperature in the bed, and a controller that determines a set temperature of the air conditioner. The controller determines the set temperature of the air conditioner in accordance with the thermal sensation gauged by the gauge and the temperature in the sleeping space measured by the first measuring unit, in a case where the first determiner determines that the state of the person is the sleep-preparation state.

With this configuration, in a case where it is determined that the state of the person is the sleep-preparation state, the set temperature for the sleeping space or the bed is determined in accordance with the thermal sensation of the person and the temperature in the sleeping space. As a result, when the person is about to fall asleep after sleep preparation, the temperature in the sleeping space or the bed can be controlled to a suitable temperature for falling asleep in accordance with the thermal sensation of the person and the temperature of the sleeping space, and therefore the person may fall asleep immediately or comfortably.

Furthermore, in the first aspect, it is preferable that the information for determining the state of the person contain information indicating an operation of the air conditioner performed by the person by using an operating unit, the operating unit being for accepting the operation of the air conditioner performed by the person. It is also preferable that the obtainer obtain from the operating unit the information indicating the operation of the air conditioner performed by the person by using the operating unit. It is also preferable that the first determiner determine in accordance with the information indicating the operation of the air conditioner performed by the person by using the operating unit whether the state of the person is the sleep-preparation state.

As preparation for sleep in a bed, a person performs, for example, a given action such as operating a function of an air conditioner, the function being likely used during sleep. With the above-described configuration, it is determined whether the state of the person is the sleep-preparation state in accordance with the information indicating the operation of the air conditioner performed by the person by using the operating unit. As a result, for example, based on the fact that the operation of the air conditioner performed by the person by using the operating unit is a given action performed by a person as a preparation for sleep in the bed, it may be correctly determined that the state of the person is the sleep-preparation state.

Moreover, the information for determining the state of the person may contain an image output by an imaging unit for outputting a captured image of the sleeping space. The obtainer may obtain from the imaging unit the image output by the imaging unit. The first determiner may determine whether the state of the person is the sleep-preparation state in accordance with an image of the person included in the image output by the imaging unit.

As preparation for sleep in a bed, for example, a person performs a given action such as covering of themselves with upper bedding, such as a comforter, on the bed. With the above-described configuration, it is determined whether the state of the person is the sleep-preparation state in accordance with the image of the person included in the image output by the imaging unit. Hence, for example, based on the fact that the action of the person specified by using the image of the person included in the image output by the imaging unit is a given action performed by a person as a preparation for sleep in the bed, it may be correctly determined that the state of the person is the sleep-preparation state.

Further, the controller may estimate the body heat level of the person in accordance with the thermal sensation gauged by the gauge and the temperature in the sleeping space measured by the first measuring unit and determine the set temperature of the air conditioner in accordance with the body heat level of the person.

With this configuration, in a case where it is determined that the state of the person is the sleep-preparation state, the set temperature for the sleeping space or the bed is determined according to the body heat level of the person estimated based on the thermal sensation of the person and the temperature in the sleeping space. As a result, when the person is about to fall asleep after sleep preparation, the temperature in the sleeping space or the bed can be controlled to a suitable temperature for falling asleep in accordance with the body heat level of the person. Accordingly, the sleeping space or the bed can be of a more suitable temperature for falling asleep, and therefore the person may fall asleep more immediately or more comfortably.

Furthermore, in the first aspect, it is preferable, in a case where the estimated body heat level of the person is a first heat level, that the controller determine the set temperature of the air conditioner to be a temperature lower than a temperature in a case where the estimated body heat level of the person is a second heat level lower than the first heat level.

It is known that increasing the body heat level enables people to easily fall asleep. Nevertheless, if the body heat level is excessively high, people in turn may not easily fall asleep. In this respect, with this configuration, in a case where it is determined that the state of the person is the sleep-preparation state, as the body heat level of the person estimated according to the thermal sensation of the person and the temperature of the sleeping space increases, it is determined to decrease the set temperature of the air conditioner. Hence, the person who is about to fall asleep after sleep preparation can be, so as to fall asleep, in the sleeping space or the bed where as the body heat level of the person increases, the temperature in the sleeping space or the bed is controlled to be decreased. As a result, the higher the body heat level of the person who is about to fall asleep after sleep preparation, the more heat is emitted from the person's body, and therefore the person may fall asleep immediately.

Moreover, it is preferable that the air conditioner control the temperature in the sleeping space.

With this configuration, in a case where it is determined that the state of the person is the sleep-preparation state, the set temperature for the sleeping space is determined according to the thermal sensation of the person and the temperature in the sleeping space. As a result, when the person is about to fall asleep after sleep preparation, the temperature in the sleeping space can be at a suitable temperature for falling asleep in accordance with the thermal sensation of the person and the temperature in the sleeping space, and therefore the person may fall asleep immediately or comfortably. In addition, since equipment for controlling temperature in sleeping spaces is common in general households, additional devices may not need to be prepared.

Further, the air conditioner may control the temperature in the bed.

With this configuration, in a case where it is determined that the state of the person is the sleep-preparation state, the set temperature for the bed is determined according to the thermal sensation of the person and the temperature in the sleeping space. As a result, when the person is about to fall asleep after sleep preparation, the temperature in the bed can be set to a suitable temperature for falling asleep in accordance with the thermal sensation of the person and the temperature of the sleeping space, and therefore the person may fall asleep immediately or comfortably. Since a bed in particular is in contact with a person who is sleeping, heat can be directly applied or released to or from the person, thereby falling asleep immediately or comfortably more effectively.

Furthermore, in the first aspect, memory that stores a correspondence between multiple combinations of the thermal sensation and the temperature of the sleeping space and multiple set temperatures corresponding to the multiple combinations may be included. The controller, by referring to the memory, may determine the set temperature of the air conditioner to be a set temperature among the multiple set temperatures, the set temperature corresponding to a combination of the thermal sensation gauged by the gauge and the temperature in the sleeping space measured by the first measuring unit among the multiple combinations.

With this configuration, in a case where it is determined that the state of the person is the sleep-preparation state, a reference is made to the memory that stores a correspondence between multiple combinations of the thermal sensation of the person and the temperature of the sleeping space and multiple set temperatures corresponding to the multiple combinations. Accordingly, the set temperature of the air conditioner is determined to be a set temperature corresponding to a combination of the thermal sensation gauged by the gauge and the temperature in the sleeping space measured by the first measuring unit.

As a result, in a case where it is determined that the state of the person is the sleep-preparation state, a set temperature according to the thermal sensation of the person gauged by the gauge and the temperature in the sleeping space measured by the first measuring unit may be promptly selected from multiple predetermined set temperatures, and thus the set temperature of the air conditioner may be promptly determined. In addition, a variety of combinations of the thermal sensation of the person and the temperature of the sleeping space are assumed. With this configuration, the set temperature of the air conditioner may be selected from multiple set temperatures corresponding to the variety of the combinations.

Moreover, the controller may change the set temperature of the air conditioner depending on an elapsed time.

With this configuration, according to the change of the body heat level depending on the elapsed time, the set temperature of the air conditioner can be changed. For example, together with the decreasing body heat level as sleep onset approaches, the temperature in the sleeping space or the bed can be decreased. As a result, immediate or comfortable falling asleep may be accelerated.

Further, it is preferable that a second determiner that determines whether the state of the person is a sleeping state, in which the person is sleeping, be included. It is also preferable, in a case where the second determiner determines that the state of the person is the sleeping state, that the controller change the set temperature of the air conditioner to a set temperature during sleep.

With this configuration, in a case where it is determined that the state of the person is the sleeping state, the set temperature of the air conditioner is changed to the set temperature during sleep. This may suppress the occurrence of sleep disturbances by maintaining the set temperature of the air conditioner even after the state of the person changed to the sleeping state.

Furthermore, it is preferable that a second measuring unit that measures biological information of the person be included. It is also preferable that the second determiner determine in accordance with the biological information whether the state of the person is the sleeping state.

With this configuration, in a case where it is determined that the state of the person is the sleeping state in accordance with the biological information of the person, the set temperature of the air conditioner is changed to the set temperature during sleep. Hence, it can be more correctly determined whether the person is in the sleeping state in accordance with the biological information of the person. This may more reliably suppress the occurrence of sleep disturbances by maintaining the set temperature of the air conditioner without change.

An air conditioning control apparatus according to a second aspect of the present disclosure causes an air conditioner to control a temperature in a sleeping space, where a person sleeps, or a temperature in a bed. The air conditioning control apparatus includes an obtainer that obtains information of thermal sensation, which is the sensation of temperature felt by the person in the sleeping space, information of the temperature in the sleeping space, and information for determining a state of the person, a first determiner that determines whether a state of the person is a sleep-preparation state, which is the state of preparing for sleep in a bed, by using the information for determining the state of the person, and a controller that determines a set temperature of the air conditioner. The controller determines the set temperature of the air conditioner in accordance with the information of thermal sensation and information of the temperature in the sleeping space that are obtained by the obtainer, in a case where the first determiner determines that the state of the person is the sleep-preparation state.

An air conditioning control method according to a third aspect of the present disclosure is for an air conditioning control system including an air conditioner that controls a temperature in a sleeping space, where a person sleeps or a temperature in a bed. The air conditioning control method includes obtaining heat distribution information about the sleeping space, the temperature in the sleeping space, and information for determining a state of the person, determining whether the state of the person is a sleep-preparation state, which is the state of preparing for sleep in a bed, by using the information for determining the state of the person, gauging thermal sensation, which is the sensation of temperature felt by the person in the sleeping space, in accordance with the heat distribution information, and determining the set temperature of the air conditioner in accordance with the gauged thermal sensation and the obtained temperature in the sleeping space, in a case where in the determining it is determined that the state of the person is the sleep-preparation state.

With these configurations, in a case where it is determined that the state of the person is the sleep-preparation state, the set temperature for the sleeping space or the bed is determined according to the thermal sensation of the person and the temperature in the sleeping space. As a result, when the person is about to fall asleep after sleep preparation, the sleeping space or the bed can be of a suitable temperature for falling asleep in accordance with the thermal sensation of the person and the temperature of the sleeping space, and therefore the person may fall asleep immediately or comfortably.

The embodiments of the present disclosure will be described below with reference to the accompanying drawings. It should be noted that any of the embodiments described below represents a general or specific example of the present disclosure. The numerical values, shapes, elements, steps, the order of steps, and the like shown in the following embodiments are mere examples and are not intended to limit the present disclosure. Furthermore, among the elements in the following embodiments, elements not recited in any of the independent claims indicating the most generic concept of the present disclosure are described as preferable elements. In addition, the contents may be mutually combined in all embodiments.

### First Embodiment

The feature of an air conditioning control system of a first embodiment is that, when a person is in a state of preparing for sleep in bed (hereinafter referred to as sleep-preparation state), in accordance with the temperature (hereinafter referred to as room temperature) of a sleeping space, where a person sleeps, and the sensation (hereinafter referred to as thermal sensation) of room temperature felt by a person in the sleeping space (hereinafter referred to as room), the room temperature is controlled. The sleep-preparation state of person includes, for example, being in the bedroom, moving toward the bed, being on the bed, and being lying on the bed until falling asleep.

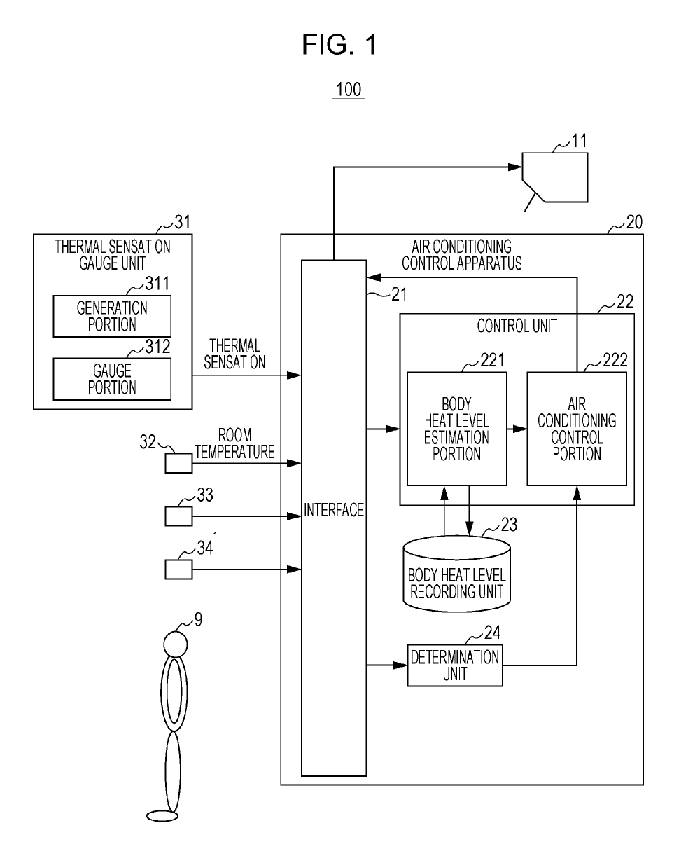

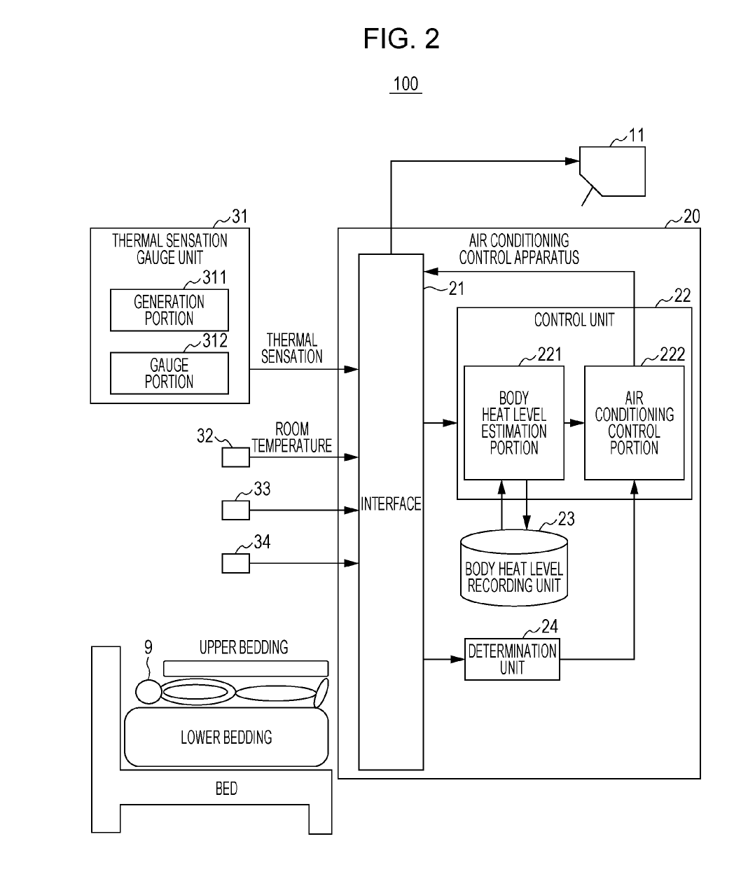

FIG. 1 is a block diagram illustrating an example of a functional configuration of an air conditioning control system 100 according to the first embodiment before a person 9 goes to sleep. FIG. 2 is a block diagram illustrating an example of a functional configuration of the air conditioning control system 100 according to the first embodiment while the person 9 is sleeping. More specifically, as illustrated in FIGS. 1 and 2, the air conditioning control system 100 includes an air conditioning unit 11, a thermal sensation gauge unit 31, a room temperature measuring unit 32 (first measuring unit), an operating unit 33, an imaging unit 34, and an air conditioning control apparatus 20.

The air conditioning unit 11, which is implemented as, for example, an air conditioning device, controls the temperature of air in a room to reach a given set temperature under the control of an air conditioning control portion 222.

The thermal sensation gauge unit 31, which is implemented as, for example, a thermal sensation sensor, gauges the thermal sensation, which is the sensation of room temperature felt by a person, for example, hot or cold. More specifically, the thermal sensation gauge unit 31 includes a generation portion 311 (an example of sensor) and a gauge portion 312.

The generation portion 311, which is implemented as, for example, a thermal image sensor, generates a thermal image (heat distribution information) representing the distribution of heat in a room in accordance with the amount of infrared radiation emitted from objects in the room. The generation portion 311 is provided in, for example, the area around a bed for the purpose of detecting the amount of infrared radiation emitted from the person 9 on the bed.

The gauge portion 312, which is implemented as a processor, such as a central processing unit (CPU), and one or more memory units, such as a random-access memory (RAM) and/or a read-only memory (ROM), gauges the thermal sensation of the person 9 in the room in accordance with the thermal image generated by the generation portion 311. For example, the thermal sensation includes “hot”, “comfortable”, “cold”, and the like.

More specifically, the gauge portion 312 specifies the human body region that is the two-dimensional region corresponding to the person 9 in the thermal image generated by the generation portion 311 and calculates the difference value between the amount of heat in the specified human body region and the amount of heat in the surrounding region of the human body region.

When the calculated difference value is below a predetermined first threshold, it is considered that heat be not lost (not released) from the human body and thus the person 9 feel hot. Accordingly, in such a case, the gauge portion 312 determines that the thermal sensation of the person 9 is “hot”.

When the calculated difference value is equal to or greater than the first threshold and below a second threshold, which is determined to be greater than the first threshold, it is considered that heat be moderately lost (released) from the human body and thus the person 9 do not feel uncomfortable. Accordingly, in such a case, the gauge portion 312 determines that the thermal sensation of the person 9 is “comfortable”.

When the calculated difference value is equal to or greater than the second threshold, it is considered that heat is greatly lost from the human body and thus the person 9 feels cold. Accordingly, in such a case, the gauge portion 312 determines that the thermal sensation of the person 9 is “cold”.

The room temperature measuring unit 32, which is implemented as, for example, a temperature sensor, measures room temperature. The room temperature measuring unit 32 is provided in, for example, the area around a bed for the purpose of measuring the temperature of the area around the bed as room temperature.

The operating unit 33, which is implemented as, for example, a remote control device capable of wireless communication, such as infrared communication, accepts an operation performed by the person 9 for the air conditioning unit 11. The operating unit 33 may be implemented as a smartphone or a tablet computer that are capable of wireless communication.

The imaging unit 34, which is implemented as, for example, a camera, outputs a captured image of a room. The imaging unit 34 is provided in, for example, an area of the ceiling of a room where the person 9 sleeps, the area being directly above a bed, for the purpose of imaging the whole bed.

The air conditioning control apparatus 20, which is implemented as, for example, a processor, a memory unit, and one or more storage device(s), such as a hard disk drive (HDD) and/or a solid-state drive (SSD), controls the air conditioning unit 11. More specifically, the air conditioning control apparatus 20 includes an interface 21 (obtainer), a control unit 22, a body heat level recording unit 23, and a determination unit 24 (first determiner).

The interface 21 is implemented as, for example, one or more interface circuits capable of wireless communication according to one or more wireless communication standards, such as Wi-Fi (registered trademark) and/or Bluetooth (registered trademark), and/or wired communication according to one or more wired communication standards, such as the Universal Serial Bus (USB) standard and/or the Ethernet (registered trademark) standard. The interface 21 communicates with an external device, such as a sensor, that is provided outside the air conditioning control apparatus 20. With this configuration, the interface 21 obtains information for determining the state of the person 9.

For example, the interface 21 receives (obtains) the thermal sensation of the person 9 gauged by the thermal sensation gauge unit 31, the room temperature measured by the room temperature measuring unit 32, the information indicating an operation of the person 9 for the air conditioning unit 11 and accepted by the operating unit 33, the captured image of the room output by the imaging unit 34. The interface 21 then outputs those kinds of received information to the control unit 22. In addition, the interface 21 transmits to the air conditioning unit 11 a command for controlling the air conditioning unit 11, the command being obtained from the air conditioning control portion 222 described below. Accordingly, the air conditioning unit 11 performs the control indicated by the received command.

The interface 21 may obtain, by communicating with an external system outside the air conditioning control system 100, from an operating unit information indicating an operation of the person 9 for the air conditioning unit 11 performed by using the operating unit. The operating unit is provided to the external system and similar to the operating unit 33. In this case, the air conditioning control system 100 may not include the operating unit 33. Likewise, the interface 21 may obtain, by communicating with an external system outside the air conditioning control system 100, from an imaging unit an image output from the imaging unit. The imaging unit is provided to the external system and that is similar to the imaging unit 34. In this case, the air conditioning control system 100 may not include the imaging unit 34.

The control unit 22, which is implemented as, for example, a processor and a memory unit, controls the entire operations of the air conditioning control apparatus 20. The control unit 22 functions as in particular a body heat level estimation portion 221 and the air conditioning control portion 222.

The body heat level estimation portion 221 estimates the body heat level of the person 9 in accordance with the room temperature measured by the room temperature measuring unit 32 and the thermal sensation gauged by the thermal sensation gauge unit 31 and causes the body heat level recording unit 23 to record the estimated body heat level of the person 9. The body heat level recording unit 23, which is implemented as, for example, one or more storage devices, such as a HDD and/or a SSD, records the body heat level of the person 9 estimated by the body heat level estimation portion 221. The body heat level recording unit 23 may be implemented as a memory unit.

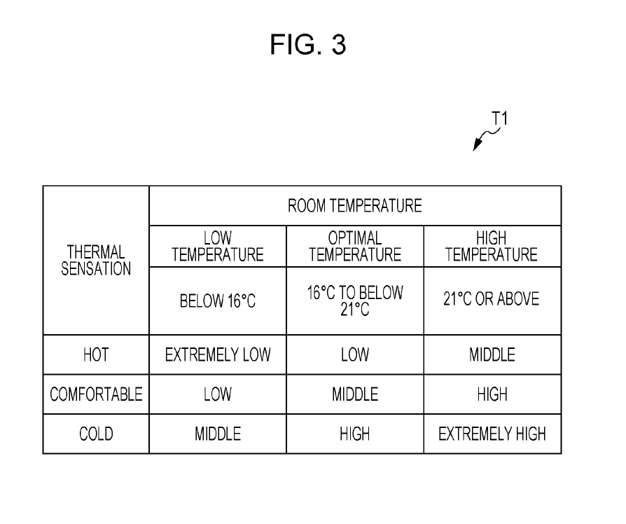

FIG. 3 illustrates an example of a first table T1. To be specific, the body heat level estimation portion 221 estimates the body heat level of the person 9 by using the first table T1 in which the correspondence between at least one combination of the thermal sensation of the person 9 and the room temperature and at least one body heat level of the person 9 is determined in advance as illustrated in FIG. 3. The first table T1 is stored in advance in, for example, the memory unit (memory) that realizes the control unit 22 and/or the storage device (memory) that realizes the body heat level recording unit 23.

For example, in the example of the first table T1 illustrated in FIG. 3, the correspondence between nine combinations of the thermal sensation of the person 9 and the room temperature and the body heat levels of the person 9 associated with the nine combinations is determined. The nine combinations are constituted by three kinds of the thermal sensation “hot”, “comfortable”, and “cold”, and three kinds of the room temperature “low temperature (below 16° C)”, “optimal temperature (16° C. to below 21° C)”, and “high temperature (21° C. or above)”.

For example, in a case where the person 9 enters a room with low temperature from extremely cold outside, the person 9 may feel hot (warm) because the temperature around them has risen. Nevertheless, in such a case, since the body is cold all over, it can be considered that the body heat level is low. Accordingly, in the first table T1 (FIG. 3), the combination of the thermal sensation “hot” and the room temperature “low temperature (below 16° C.)” is associated with the body heat level “extremely low”.

In a case where the person 9 enters a room with high temperature immediately after the exercise, the person 9 may feel cold (cool) because the body is very hot due to the exercise. However, in such a case, it can be considered that the body heat level is significantly high. Accordingly, in the first table T1 (FIG. 3), the combination of the thermal sensation “cold” and the room temperature “high temperature (21° C. or above)” is associated with the body heat level “extremely high”.

Under the same concept, the combination of the thermal sensation “hot” and the room temperature “optimal temperature (16° C. to below 21° C.)” and the combination of the thermal sensation “comfortable” and the room temperature “low temperature (below 16° C.)” are associated with the body heat level “low”. The body heat level “low” represents a body heat level higher than the body heat level “extremely low”.

The combination of the thermal sensation “hot” and the room temperature “high temperature (21° C. or above)”, the combination of the thermal sensation “comfortable” and the room temperature “optimal temperature (16° C. to below 21° C)”, and the combination of the thermal sensation “cold” and the room temperature “low temperature (below 16° C.)” are associated with the body heat level “middle”. The body heat level “middle” represents a body heat level higher than the body heat level “low”.

The combination of the thermal sensation “comfortable” and the room temperature “high temperature (21° C. or above)” and the combination of the thermal sensation “cold” and the room temperature “optimal temperature (16° C. to below 21° C.)” are associated with the body heat level “high”. The body heat level “high” represents a body heat level higher than the body heat level “middle” and lower than the body heat level “extremely high”.

As described above, in the first table T1 illustrated in FIG. 3, the nine combinations of the thermal sensation of the person 9 and the room temperature are associated with the five kinds of the body heat level “extremely low”, “low”, “middle”, “high”, and “extremely high”.

For example, it is assumed that the thermal sensation of the person 9 gauged by the thermal sensation gauge unit 31 is “comfortable” and the room temperature measured by the room temperature measuring unit 32 is “optimal temperature (16° C. to below 21° C)”. In this case, the body heat level estimation portion 221 estimates that the body heat level of the person 9 is “middle”, which corresponds to the combination of the thermal sensation “comfortable” and the room temperature “optimal temperature (16° C. to below 21° C.)” in the first table T1 (FIG. 3). In addition, the body heat level estimation portion 221 causes the body heat level recording unit 23 to record the estimated body heat level “middle”. Referring back to FIGS. 1 and 2, in a case where the determination unit 24 determines that the state of the person 9 is the sleep-preparation state as described later, the air conditioning control portion 222 determines the set temperature of the air conditioning unit 11 in accordance with the body heat level of the person 9 estimated by the body heat level estimation portion 221.

Subsequently, the air conditioning control portion 222 causes the air conditioning unit 11 to control room temperature to reach the determined set temperature. More specifically, the air conditioning control portion 222 sends a command for controlling room temperature to reach the determined set temperature via the interface 21 to the air conditioning unit 11. According to the received command, the air conditioning unit 11 controls room temperature to reach the set temperature determined by the air conditioning control portion 222.

The determination unit 24 is implemented as, for example, a processor and a memory unit. The determination unit 24 determines whether the state of the person 9 in the room is the sleep-preparation state in accordance with the information indicating an operation of the person 9 for the air conditioning unit 11 accepted by the operating unit 33 and/or the image of the person 9 included in the captured image of the room output by the imaging unit 34, the information and the image of the person 9 being received by the interface 21. The determination unit 24 may be implemented as the same processor and the same memory unit as those of the control unit 22, or a different processor and a different memory unit from those of the control unit 22.

For example, when the operation of the person 9 for the air conditioning unit 11 that is accepted by the operating unit 33 and indicated by the information received by the interface 21 is an operation for a functionality of the air conditioning unit 11, the functionality being likely used during sleep, the determination unit 24 determines that the person 9 is in the sleep-preparation state. The functionality likely used during sleep includes, for example, a sleep timer function for keeping the air conditioning unit 11 operating until a preset time elapses.

Moreover, it is assumed that the determination unit 24 detects, by performing known image recognition processing, the person 9 is included in the captured image of the room that is output by the imaging unit 34 and that is received by the interface 21. In this case, the determination unit 24 further detects, by performing known image recognition processing, the motion of the person 9 in accordance with the characteristic quantity of the image representing the detected person 9. Furthermore, the determination unit 24 detects, by performing known image recognition processing, an object around the detected person 9 in accordance with the characteristic quantity of the image representing the object around the detected person 9.

As a result, for example, in a case where the determination unit 24 detects that the person 9 is present in an area around which the lower bedding, such as a bed or a mattress, is present, the determination unit 24 determines that the person 9 is in a bedroom and therefore in the sleep-preparation state. Furthermore, in a case where the determination unit 24 detects that the person 9 is moving toward the lower bedding or the upper bedding, such as a comforter, the determination unit 24 determines that the person 9 is moving toward a bed and therefore in the sleep-preparation state. Moreover, in a case where the determination unit 24 detects that the person 9 is on the lower bedding, the determination unit 24 determines that the person 9 is on a bed and therefore in the sleep-preparation state. Further, in a case where the determination unit 24 detects that the person 9 is lying on the lower bedding and covered with the upper bedding, the determination unit 24 determines that the person 9 is lying on a bed until falling asleep and therefore in the sleep-preparation state. The method for determining whether the person 9 is in the sleep-preparation state by using the determination unit 24 is not limited to the above-described methods.

The air conditioning control apparatus 20 is, for example, provided in the vicinity of the air conditioning unit 11 so that the air conditioning control portion 222 and the air conditioning unit 11 can reliably communicate with each other via the interface 21. In addition, at least one of the thermal sensation gauge unit 31, the room temperature measuring unit 32, the operating unit 33, and the imaging unit 34 may be provided in the air conditioning unit 11.

In addition, the thermal sensation gauge unit 31, the room temperature measuring unit 32, the operating unit 33, and the imaging unit 34 may be provided in the air conditioning control apparatus 20, and the air conditioning control apparatus 20 may be provided in the air conditioning unit 11. In such a case, the air conditioning control apparatus 20 may not be equipped with the interface 21, where the thermal sensation gauge unit 31, the room temperature measuring unit 32, and the control unit 22 are communicably connected, the operating unit 33, the imaging unit 34, and the determination unit 24 are communicably connected, and the control unit 22 and the air conditioning unit 11 are communicably connected.

### (Decision Operation of Set Temperature)

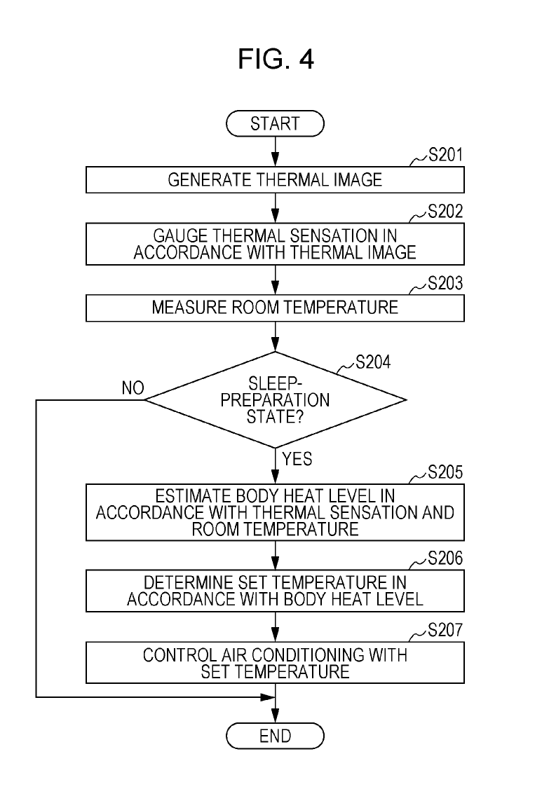

Next, an operation of determining a set temperature of the air conditioning unit 11 will be described. FIG. 4 is a flowchart illustrating an example of an operation of determining a set temperature of the air conditioning unit 11. As illustrated in FIG. 4, the thermal sensation gauge unit 31 causes the generation portion 311 to generate a thermal image representing the distribution of heat in a room (S201). The thermal sensation gauge unit 31 subsequently causes the gauge portion 312 to gauge the thermal sensation of the person 9 in accordance with the thermal image generated in S201 and then to transmit the measured thermal sensation of the person 9 to the air conditioning control apparatus 20 (S202). The room temperature measuring unit 32 measures the room temperature and transmits the measured room temperature to the air conditioning control apparatus 20 (S203).

Next, the determination unit 24 determines whether the state of the person 9 is the sleep-preparation state (S204). In a case where the determination unit 24 determines that the state of the person 9 is not the sleep-preparation state (NO in S204), the operation of determining a set temperature of the air conditioning unit 11 is ended.

Conversely, in a case where the determination unit 24 determines that the state of the person 9 is the sleep-preparation state (YES in S204), the body heat level estimation portion 221 estimates the body heat level of the person 9 in accordance with the thermal sensation gauged in S202 and the room temperature measured in S203 by using the first table T1 (FIG. 3) as described above and causes the body heat level recording unit 23 to record the estimated body heat level (S205).

Subsequently, the air conditioning control portion 222 determines the set temperature of the air conditioning unit 11 in accordance with the body heat level recorded in the body heat level recording unit 23 (S206). The air conditioning control portion 222 then causes the air conditioning unit 11 to control room temperature to reach the set temperature determined in S206 (S207).

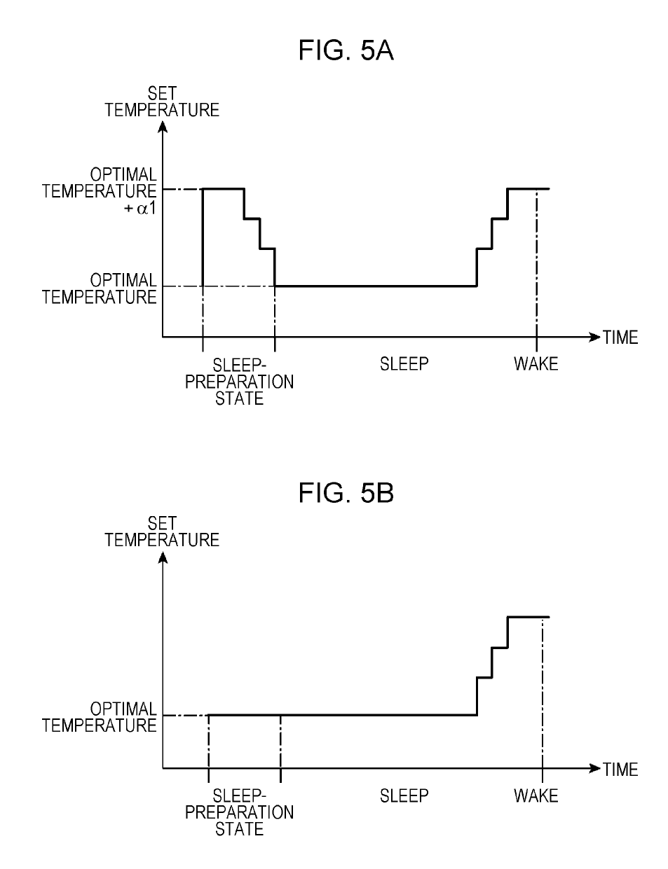

FIGS. 5A and 5B are graphs illustrating examples of the set temperature determined by the air conditioning control portion 222. In order that the person 9 sleeps comfortably, the core body temperature needs to be decreased when they fall asleep. This can be realized in the environment where blood flow is increased by warming hands and feet and heat can be emitted from peripheral blood vessels.

Accordingly, as illustrated in FIG. 5A, in a case where the body heat level recorded in the body heat level recording unit 23 is the body heat level (second heat level) equal to or below “middle” (FIG. 3), the air conditioning control portion 222 determines, in S206 (FIG. 4), the set temperature of the air conditioning unit 11 to be the temperature “optimal temperature+α1” higher than the predetermined set temperature during sleep “optimal temperature” by a given temperature “α1”. The body heat level equal to or below “middle” means that the body heat level is “middle”, “low”, or “extremely low” (FIG. 3).

The set temperature during sleep is predetermined at 25° C. to 28° C. in summer, 16° C. to 20° C. in winter. The predetermined set temperature during sleep is recorded in, for example, the memory unit that realizes the control unit 22 and/or the storage device that realizes the body heat level recording unit 23. It should be noted that the set temperature during sleep is not limited to the aforementioned temperatures. In addition, the set temperature during sleep can be set at various levels of temperature at an arbitrary time by using the operating unit 33.

In S207 (FIG. 4), the air conditioning control portion 222 causes the air conditioning unit 11 to control room temperature to reach the set temperature “optimal temperature+α1” higher than the set temperature during sleep “optimal temperature” determined in S206. As a result, the hands and feet of the person 9 become warm and the blood flow in hands and feet increases, thereby emitting heat from peripheral blood vessels. This accelerates the lowering of core body temperature of the person 9, and therefore the person 9 can easily fall asleep.

After a predetermined time has elapsed since the room temperature measured by the room temperature measuring unit 32 reached the set temperature determined in S206, the air conditioning control portion 222 gradually decreases the set temperature of the air conditioning unit 11 depending on the elapsed time until the room temperature reaches the set temperature during sleep “optimal temperature”. Alternatively, the air conditioning control portion 222 may perform control for decreasing the set temperature of the air conditioning unit 11 at one time to reach the set temperature during sleep “optimal temperature”.

By contrast, it is assumed that, in S206, the body heat level recorded in the body heat level recording unit 23 is “high” or “extremely high”. In this case, if the set temperature of the air conditioning unit 11 is set, similarly to the case where the body heat level is equal to or below “middle”, to a temperature higher than the set temperature during sleep “optimal temperature”, the room temperature becomes higher than body temperature and heat radiation is hindered, and therefore the lowering of core body temperature may be prevented.

Hence, as illustrated in FIG. 5B, in a case where the body heat level recorded in the body heat level recording unit 23 is the body heat level (first heat level) equal to “high” or “extremely high”, the air conditioning control portion 222 determines, in S206, the set temperature of the air conditioning unit 11 to be the set temperature during sleep “optimal temperature” lower than the temperature “optimal temperature+α1” that is used in the case where the body heat level is equal to or below “middle”.

Subsequently, in S207, the air conditioning control portion 222 causes the air conditioning unit 11 to control the room temperature to reach the set temperature determined in S206. As a result, the lowering of core body temperature cannot be prevented.

When the person 9 wakes, the body increases core body temperature to get ready to awake. Accordingly, after predetermined sleep duration (for example, six hours) has elapsed since it was determined by the determination unit 24 that the state of the person 9 was the sleep-preparation state, the air conditioning control portion 222 gradually increases the set temperature of the air conditioning unit 11 as illustrated in FIGS. 5A and 5B. In this manner, room temperature is raised and the raising of core body temperature is accelerated, and therefore the person 9 can awake easily.

As described above, with the configuration according to the first embodiment, when the state of the person 9 is the sleep-preparation state, the set temperature of the air conditioning unit 11 is determined in consideration of the body heat level of the person 9 so as to accelerate the lowering of core body temperature when the person 9 falls asleep. As a result, the lowering of core body temperature may be accelerated when the person 9 falls asleep after sleep preparation, and therefore the person 9 may fall asleep immediately or comfortably.

### Second Embodiment

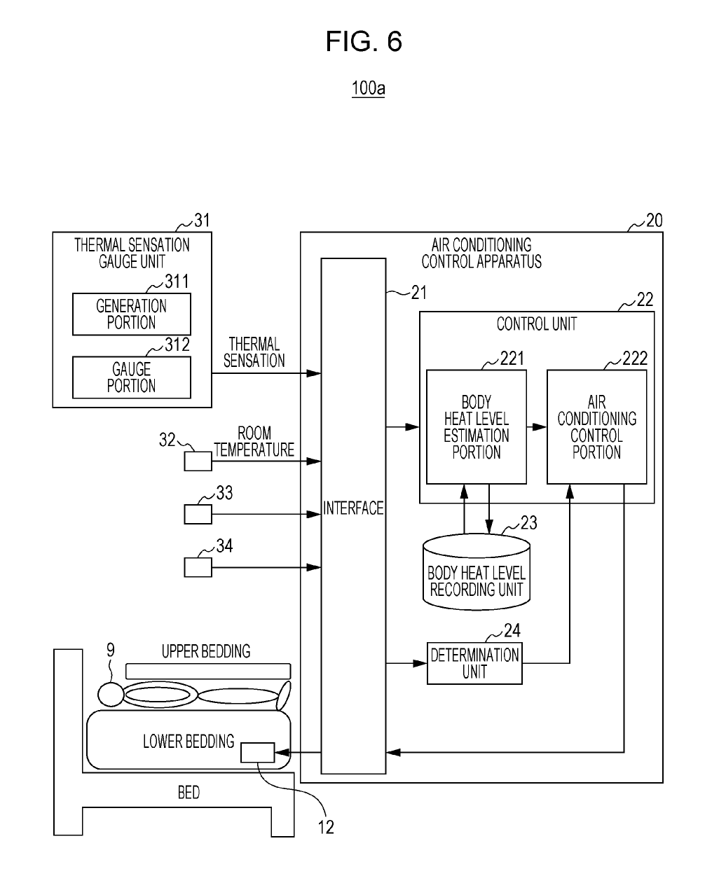

Next, an air conditioning control system 100a according to a second embodiment will be described. FIG. 6 is a block diagram illustrating an example of a functional configuration of the air conditioning control system 100a according to the second embodiment when the person 9 is sleeping. In the air conditioning control system 100 (FIGS. 1 and 2) according to the first embodiment, the air conditioning control portion 222 causes the air conditioning unit 11, which is an air conditioning device, to control room temperature to reach the set temperature determined in S206 (FIG. 4).

As illustrated in FIG. 6, unlike the air conditioning control system 100 according to the first embodiment, the air conditioning control system 100a according to the second embodiment includes an in-bed air conditioning unit 12 (air conditioner) instead of the air conditioning unit 11.

The in-bed air conditioning unit 12 is implemented as, for example, an electric blanket for heating the bed, a device for heating or cooling the bed by using oil or water, a fan installed on the bottom of bed, and/or a fan device provided near the bed. The in-bed air conditioning unit 12 controls temperature in the bed to reach a predetermined set temperature under the control of the air conditioning control portion 222.

Unlike the first embodiment, in S206 (FIG. 4), the air conditioning control portion 222 determines a set temperature of the in-bed air conditioning unit 12 in accordance with the body heat level of the person 9 recorded in the body heat level recording unit 23. In S207 (FIG. 4), the air conditioning control portion 222 causes the in-bed air conditioning unit 12 to control temperature in the bed to reach the set temperature determined in S206.

More specifically, in S207 (FIG. 4), the air conditioning control portion 222 sends a command for controlling temperature in the bed to reach the set temperature determined in S206 via the interface 21 to the in-bed air conditioning unit 12. According to the received command, the in-bed air conditioning unit 12 controls temperature in the bed to reach the set temperature determined in S206.

It is known that, in any season, when temperature in the bed is from 32° C. to 34° C., comfortable sleep can be achieved. Hence, the set temperature during sleep used when the air conditioning control portion 222 determines a set temperature in S206 (FIG. 4) is predetermined at 32° C. to 34° C., unlike the first embodiment. Since other configurations are the same as those of the first embodiment, the description is omitted. It should be noted that the set temperature during sleep is not limited the above-described temperatures. In addition, similarly to the first embodiment, the set temperature can be set at various levels of temperature at an arbitrary time by using the operating unit 33.

As described above, with the configuration according to the second embodiment, when the state of the person 9 is the sleep-preparation state, the set temperature of the in-bed air conditioning unit 12 is set in consideration of the body heat level of the person 9 so as to accelerate the lowering of core body temperature when the person 9 falls asleep. As a result, the lowering of core body temperature may be accelerated when the person 9 falls asleep after sleep preparation, and therefore the person 9 may fall asleep immediately or comfortably.

The above-described first and second embodiments are mere examples of embodiments according to the present disclosure and not intended to limit the present disclosure. For example, modified embodiments described below may be applied.

### First Modified Embodiment

The first and second embodiments may be combined such that the air conditioning control system 100 or 100a includes both the air conditioning unit 11 and the in-bed air conditioning unit 12. In S206 (FIG. 4), the air conditioning control portion 222 may determine set temperatures of the air conditioning unit 11 and the in-bed air conditioning unit 12 in accordance with the body heat level recorded in the body heat level recording unit 23. Accordingly, in S207 (FIG. 4), the air conditioning control portion 222 may cause the air conditioning unit 11 to control room temperature to reach the set temperature of the air conditioning unit 11 determined in S206 and the in-bed air conditioning unit 12 to control temperature in the bed to reach the set temperature of the in-bed air conditioning unit 12 determined in S206.

### Second Modified Embodiment

In S206 (FIG. 4), the air conditioning control portion 222 may determine the set temperature of the air conditioning unit 11 according to the first embodiment to be a set temperature that, in set temperature information, corresponds to a combination of the thermal sensation gauged by the thermal sensation gauge unit 31 and the room temperature measured by the room temperature measuring unit 32. In the set temperature information, the correspondence between at least one combination of the thermal sensation of the person 9 and the room temperature and at least one set temperature is determined in advance.

Similarly, in S206 (FIG. 4), the air conditioning control portion 222 may determine the set temperature of the in-bed air conditioning unit 12 according to the second embodiment to be a set temperature that, in the set temperature information, corresponds to a combination of the thermal sensation gauged by the thermal sensation gauge unit 31 and the room temperature measured by the room temperature measuring unit 32.

Hereinafter, the set temperature of the air conditioning unit 11 according to the first embodiment and the set temperature of the in-bed air conditioning unit 12 according to the second embodiment will be collectively referred to as the set temperature of the air conditioning unit.

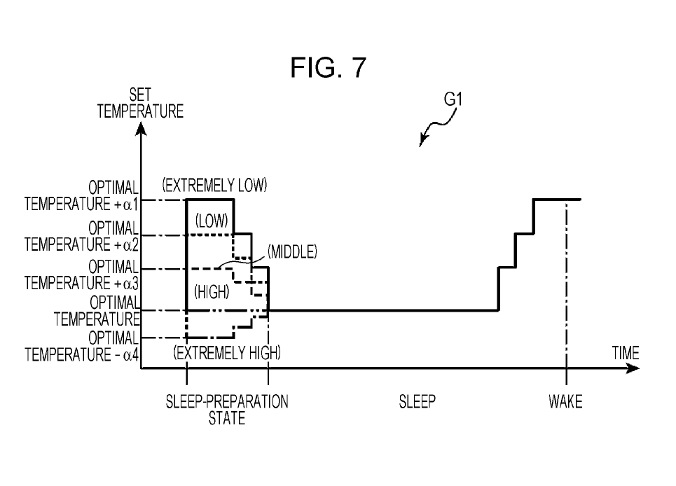

FIG. 7 illustrates an example of a first graph G1. To be specific, the set temperature information is constituted by the first table T1 illustrated in FIG. 3 and the first graph G1 illustrated in FIG. 7. In the first table T1 (FIG. 3), the correspondence between at least one combination of the thermal sensation of the person 9 and the room temperature and at least one body heat level is determined in advance as described above. In the first graph G1, as illustrated in FIG. 7, the correspondence between at least one body heat level that can be estimated by the body heat level estimation portion 221 and that is included in the first table T1 and at least one set temperature of the air conditioning unit is determined in advance. The information represented by the first graph G1 is, similarly to the first table T1, stored in advance in, for example, the memory unit (memory) that realizes the control unit 22 and/or the storage device (memory) that realizes the body heat level recording unit 23.

For example, in the first graph G1 illustrated in FIG. 7, five kinds of the set temperature of the air conditioning unit “optimal temperature+α1”, “optimal temperature+α2”, “optimal temperature+α3”, “optimal temperature”, “optimal temperature−α4” are determined in association with the respective five kinds of body heat level “extremely low”, “low”, “middle”, “high”, and “extremely high”, which are included in the first table T1. The set temperature of the air conditioning unit “optimal temperature−α4” represents the temperature lower than the set temperature during sleep “optimal temperature” by a given temperature “α4”.

In S206 (FIG. 4) of the second modified embodiment, the air conditioning control portion 222 determines the set temperature of the air conditioning unit to be a set temperature associated, in the first graph G1 (FIG. 7) constituting part of the set temperature information, with the body heat level estimated in S205 (FIG. 4). The estimated body heat level corresponds to a combination of the room temperature measured in S203 (FIG. 4) and the thermal sensation gauged in S202 (FIG. 4) in the first table T1 (FIG. 3) constituting part of the set temperature information.

For example, it is assumed that the thermal sensation gauged in S202 (FIG. 4) is “cold” and the room temperature measured in S203 (FIG. 4) is “low temperature (below 16° C)”. In this case, the body heat level “middle” corresponding to the combination of the thermal sensation “cold” and the room temperature “low temperature (below 16° C.)” in the first table T1 (FIG. 3) is estimated in S205 (FIG. 4). In this case, in S206 (FIG. 4), the air conditioning control portion 222 determines the set temperature of the air conditioning unit to be the set temperature “optimal temperature+α3” that is associated with the body heat level “middle” in the first graph G1 (FIG. 7).

For example, it is assumed that the thermal sensation gauged in S202 (FIG. 4) is “cold” and the room temperature measured in S203 (FIG. 4) is “high temperature (21° C. or above)”. In this case, the body heat level “extremely high” corresponding to the combination of the thermal sensation “cold” and the room temperature “high temperature (21° C. or above)” in the first table T1 (FIG. 3) is estimated in S205 (FIG. 4). In this case, in S206 (FIG. 4), the air conditioning control portion 222 determines the set temperature of the air conditioning unit to be the set temperature “ optimal temperature−α4” that is associated with the body heat level “extremely high” in the first graph G1 (FIG. 7).

Here, it is assumed that the set temperature determined in S206 is equal to or above the set temperature during sleep “optimal temperature”. In this case, similarly to the first embodiment, after a predetermined time has elapsed since the room temperature measured by the room temperature measuring unit 32 reached the set temperature determined in S206, the air conditioning control portion 222 gradually decreases the set temperature of the air conditioning unit depending on the elapsed time until the room temperature reaches the set temperature during sleep “optimal temperature”. Alternatively, the air conditioning control portion 222 may perform control for decreasing the set temperature of the air conditioning unit at one time to reach the set temperature during sleep “optimal temperature”.

By contrast, it is assumed that the set temperature determined in S206 is below the set temperature during sleep “optimal temperature”. In this case, after a predetermined time has elapsed since the room temperature measured by the room temperature measuring unit 32 reached the set temperature determined in S206, the air conditioning control portion 222 gradually increases the set temperature of the air conditioning unit until the room temperature reaches the set temperature during sleep “optimal temperature”. Alternatively, the air conditioning control portion 222 may perform control for increasing the set temperature of the air conditioning unit at one time to reach the set temperature during sleep “optimal temperature”.

With the configuration according to the second modified embodiment, when the state of the person 9 is the sleep-preparation state, the set temperature of the air conditioning unit is determined in consideration of the body heat level of the person 9 so as to accelerate the lowering of core body temperature when the person 9 falls asleep. As a result, the lowering of core body temperature is accelerated when the person 9 falls asleep after sleep preparation, and therefore the person 9 may fall asleep immediately or comfortably.

### Third Modified Embodiment

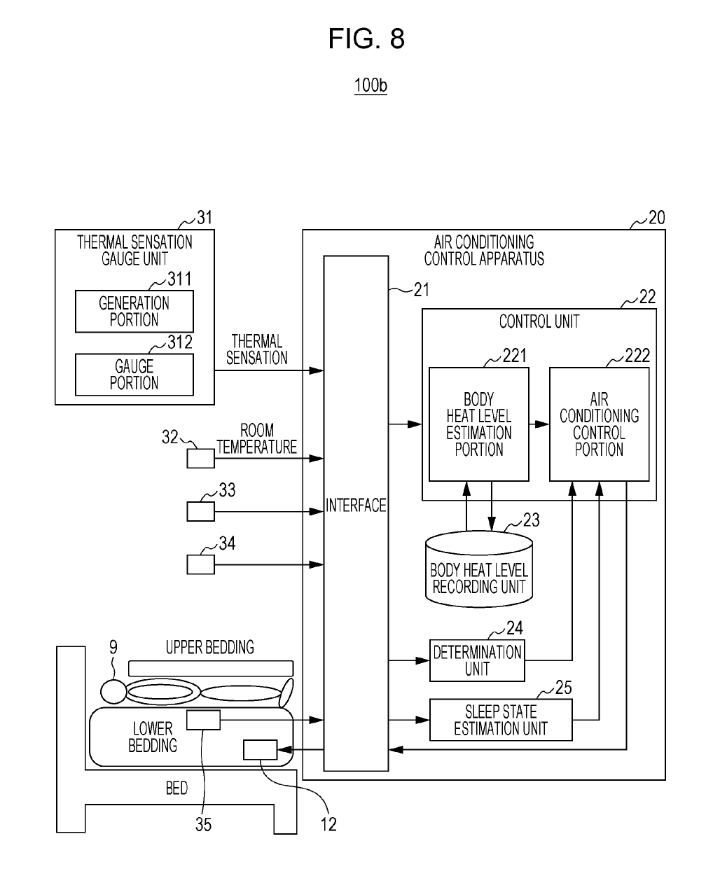

FIG. 8 is a block diagram illustrating an example of a functional configuration of an air conditioning control system 100b according to a third modified embodiment when the person 9 is sleeping. As illustrated in FIG. 8, the air conditioning control system 100b may be configured such that a biological information measuring unit 35 (second measuring unit) and a sleep state estimation unit 25 (second determiner) are added to the configuration of the air conditioning control system 100a (FIG. 6) according to the second embodiment.

The biological information measuring unit 35, which is implemented as, for example, a radio frequency sensor and/or a vital sensor, measures biological information of the person 9, such as information about body motion, heartbeat, and respiration. The vital sensor that implements the biological information measuring unit 35 may be a wearable vital sensor capable of being worn by the person 9 or a sheet-type vital sensor that is spread under the lower bedding on the bed.

The sleep state estimation unit 25, which is implemented as, a processor and a memory unit, determines whether the state of the person 9 is the sleeping state, in which the person 9 is sleeping, by performing known sleep state determination processing using the biological information measured by the biological information measuring unit 35. The sleep state estimation unit 25 may be implemented as the same processor and the same memory unit as those of the control unit 22, or a different processor and a different memory unit from those of the control unit 22.

According to this, after S207 (FIG. 4) is started, the air conditioning control portion 222 may cause the sleep state estimation unit 25 to periodically determine the state of the person 9. When it is determined that the state of the person 9 is the sleeping state, the set temperature of the in-bed air conditioning unit 12 may be changed to the predetermined set temperature during sleep “optimal temperature”.

Likewise, the biological information measuring unit 35 and the sleep state estimation unit 25 may be added to the air conditioning control system 100 (FIGS. 1 and 2) according to the first embodiment. Accordingly, after S207 (FIG. 4) is started, the air conditioning control portion 222 may cause the sleep state estimation unit 25 to periodically determine the state of the person 9. When it is determined that the state of the person 9 is the sleeping state, the set temperature of the air conditioning unit 11 may be changed to the predetermined set temperature during sleep “optimal temperature”. Furthermore, similarly to these, the first and second modified embodiments may be further modified.

### Fourth Modified Embodiment

The air conditioning control systems explained in the third modified embodiment may not include the biological information measuring unit 35 (FIG. 8). Accordingly, the sleep state estimation unit 25 (FIG. 8), in S204 (FIG. 4), may determine that the state of the person 9 is the awake state, in which the person 9 is not sleeping, during the period from when the determination unit 24 determines that the state of the person 9 is the sleep-preparation state to when a predetermined fall asleep time (for example, one hour) has elapsed since. The sleep state estimation unit 25 may determine that the state of the person 9 is the sleeping state after the fall asleep time has elapsed.

### Fifth Modified Embodiment

In the first and second embodiments and the first to fourth modified embodiments, the air conditioning control system 100, 100a, or 100b may not include the body heat level estimation portion 221 and the body heat level recording unit 23. Accordingly, S205 (FIG. 4) may be omitted. In S206 (FIG. 4), the air conditioning control portion 222 may determine the set temperature of the air conditioning unit (the air conditioning unit 11 and the in-bed air conditioning unit 12) in accordance with the thermal sensation gauged in S202 and the room temperature measured in S203.

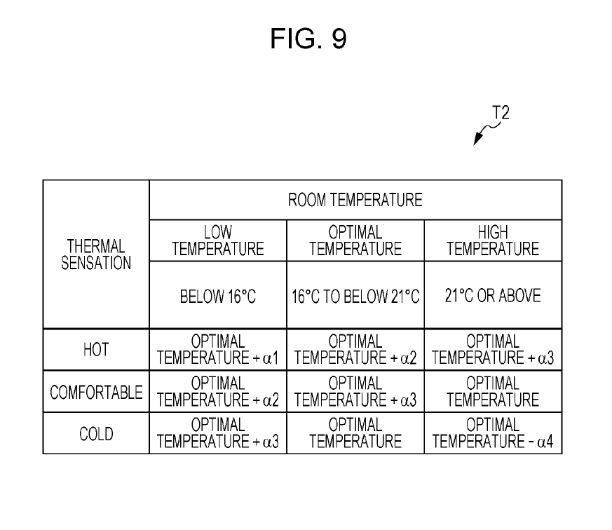

FIG. 9 illustrates an example of a second table T2. To be specific, in S206 of the fifth modified embodiment, the air conditioning control portion 222 determine the set temperature of the air conditioning unit with reference to, instead of the first table T1 (FIG. 3), the second table T2 in which the correspondence between at least one combination of the thermal sensation and the room temperature and at least one set temperature of the air conditioning unit is determined in advance as illustrated in FIG. 9. The second table T2 is stored in advance in, for example, the memory unit (memory) that realizes the control unit 22 and/or the storage device (memory) that realizes the body heat level recording unit 23.

For example, in the second table T2 illustrated in FIG. 9, the correspondence between nine combinations of the thermal sensation of the person 9 and the room temperature and five kinds of the set temperature of the air conditioning unit is determined. The nine combinations are constituted by three kinds of the thermal sensation of the person 9 “hot”, “comfortable”, and “cold”, and three kinds of the room temperature “low temperature (below 16° C)”, “optimal temperature (16° C. to below 21° C)”, and “high temperature (21° C. or above)”. The five kinds of the set temperature of the air conditioning unit are “optimal temperature+α1”, “optimal temperature+α2”, “optimal temperature+α3”, “optimal temperature”, and “optimal temperature−α4”.

The at least one set temperature of the air conditioning unit (for example, “optimal temperature+α1”, “optimal temperature+α2”, “optimal temperature+α3”, “optimal temperature”, and “optimal temperature−α4”) included in the second table T2 can be the same as the at least one set temperature of the air conditioning unit (for example, “optimal temperature+α1”, “optimal temperature+α2”, “optimal temperature+α3”, “optimal temperature”, and “optimal temperature−α4”) included in the first graph G1 (FIG. 7). In other words, the second table T2 can be determined such that as the body heat level estimated according to a combination of the thermal sensation and the room temperature increases, the set temperature of the air conditioning unit corresponding to the combination decreases.

For example, it is assumed that the thermal sensation of the person 9 gauged in S202 is “hot” and the room temperature measured in S203 is “low temperature (below 16° C)”. In this case, in S206 of the fifth modified embodiment, the air conditioning control portion 222 determines the set temperature of the air conditioning unit to be the set temperature “optimal temperature+α1” corresponding to the combination of the thermal sensation “hot” and the room temperature “low temperature (below 16° C.)” with reference to the second table T2 (FIG. 9).

In the above-described embodiments and the modified embodiments, some aspects of the present disclosure are applied to a local air conditioning control system. In the local air conditioning control system, the single air conditioning control apparatus 20 communicates with the thermal sensation gauge unit 31, the room temperature measuring unit 32, the operating unit 33, and the imaging unit 34 that are installed in a single room so as to control the air conditioning unit 11 installed in the single room.

However, the present disclosure may be applied to not only the local air conditioning control system but also an overall air conditioning control system (for example, a central-heating-type air conditioning control system). In the overall air conditioning control system, a single air conditioning control apparatus similar to the air conditioning control apparatus 20 communicates with the thermal sensation gauge unit 31, the room temperature measuring unit 32, the operating unit 33, and the imaging unit 34 that are installed in at least one room among multiple rooms so as to control the air conditioning unit 11 for controlling air to be sent into each of the multiple rooms.

The present disclosure controls thermal environment of the sleeping space or the bed during sleep preparation in accordance with thermal sensation of a person and room temperature. This accelerates the lowering of core body temperature of the person when they go to sleep, and therefore the person may easily fall asleep.

What is claimed is:

1. An air conditioning control system, comprising:
a first sensor that generates heat distribution information about a sleeping space where a person sleeps;
a receiver that receives information for determining a state of the person;
a first determiner that determines whether the state of the person is a sleep-preparation state, which is a state of preparing for sleep in a bed, by using the information for determining the state of the person;
a gauge that gauges thermal sensation, which is the sensation of temperature felt by the person in the sleeping space, in accordance with the heat distribution information;
a temperature measure that measures the temperature in the sleeping space;
an air conditioner that controls the temperature in the sleeping space or a temperature in the bed; and
a controller that determines a set temperature of the air conditioner,
wherein, when the first determiner determines that the state of the person is the sleep-preparation state, the controller determines the set temperature of the air conditioner in accordance with the gauged thermal sensation and the measured temperature in the sleeping space.

2. The air conditioning control system according to claim 1, wherein
the information for determining the state of the person contains information indicating an operation of the air conditioner performed by the person by using an user interface, the user interface accepting the operation of the air conditioner performed by the person,
the receiver receives, from the user interface, the information indicating the operation of the air conditioner performed by the person, and
the first determiner determines whether the state of the person is the sleep-preparation state in accordance with the information indicating the operation of the air conditioner performed by the person.

3. The air conditioning control system according to claim 1, wherein
the information for determining the state of the person contains an image output by a camera capturing an image of the sleeping space,
the receiver receives, from the camera, the output image, and
the first determiner determines whether the state of the person is the sleep-preparation state in accordance with an image of the person included in the output image.

4. The air conditioning control system according to claim 1, wherein the controller estimates a body heat level of the person in accordance with the gauged thermal sensation and the measured temperature in the sleeping space and determines the set temperature of the air conditioner in accordance with the body heat level of the person.

5. The air conditioning control system according to claim 4, wherein when the estimated body heat level of the person is a first heat level, the controller determines the set temperature of the air conditioner to be a temperature lower than a temperature in a case where the estimated body heat level of the person is a second heat level lower than the first heat level.

6. The air conditioning control system according to claim 1, wherein the air conditioner controls the temperature in the sleeping space.

7. The air conditioning control system according to claim 1, wherein the air conditioner controls the temperature in the bed.

8. The air conditioning control system according to claim 1, further comprising a memory that stores a correspondence between multiple combinations of the thermal sensation and the temperature of the sleeping space and multiple set temperatures corresponding to the multiple combinations,
wherein the controller, by referring to the memory, determines the set temperature of the air conditioner to be a set temperature among the multiple set temperatures, the set temperature corresponding to a combination of the gauged thermal sensation and the measured temperature in the sleeping space among the multiple combinations.

9. The air conditioning control system according to claim 1, wherein the controller changes the set temperature of the air conditioner depending on an elapsed time.

10. The air conditioning control system according to claim 1, further comprising a second determiner that determines whether the state of the person is a sleeping state, in which the person is sleeping,
wherein, when the second determiner determines that the state of the person is the sleeping state, the controller changes the set temperature of the air conditioner to a set temperature during sleep.

11. The air conditioning control system according to claim 10, further comprising a second sensor that measures biological information of the person,
wherein the second determiner determines whether the state of the person is the sleeping state in accordance with the biological information.

12. An air conditioning control apparatus that causes an air conditioner to control a temperature in a sleeping space, where a person sleeps, or a temperature in a bed, the air conditioning control apparatus comprising:
a receiver that receives information of thermal sensation, which is a sensation of temperature felt by the person in the sleeping space, information of the temperature in the sleeping space, and information for determining a state of the person;
a first determiner that determines whether the state of the person is a sleep-preparation state, which is a state of preparing for sleep in a bed, by using the information for determining the state of the person; and
a controller that determines a set temperature of the air conditioner,
wherein, when the first determiner determines that the state of the person is the sleep-preparation state, the controller determines the set temperature of the air conditioner in accordance with the information of the thermal sensation and the information of the temperature in the sleeping space.

13. An air conditioning control method for an air conditioning control system including an air conditioner that controls a temperature in a sleeping space, where a person sleeps, or a temperature in a bed, the air conditioning control method comprising:
receiving heat distribution information about the sleeping space, the temperature in the sleeping space, and information for determining a state of the person;
determining whether the state of the person is a sleep-preparation state, which is the state of preparing for sleep in a bed, by using the information for determining the state of the person;
gauging thermal sensation, which is a sensation of temperature felt by the person in the sleeping space, in accordance with the heat distribution information; and
determining the set temperature of the air conditioner in accordance with the gauged thermal sensation and the obtained temperature in the sleeping space, when in the determining of the state of the person it is determined that the state of the person is the sleep-preparation state.
